(19) United States
(12) Patent Application Publication
(10) Pub. No.: US 2002/0108441 A1
(43) Pub. Date: Aug. 15, 2002

(54) Armless fluid level measuring device having sealed housing tube and external float

(76) Inventor: Paul Liu, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 09/781,409

(22) Filed: Feb. 13, 2001

(51) Int. Cl. G01F 23/30

(52) U.S. Cl. 73/305; 73/319; 73/313

(57) ABSTRACT

An improved armless fluid level measuring device has a sealed housing tube and an externally exposed float. The float is slidably attached to the outer surface of the housing tube in which an elongated PC board is sealedly confined so as to protect the PC board from being sabotaged or eroded by fluid chemicals. The float provided with a plurality of high density magnet is slidable on the external surface of the housing tube. The PC board has a circuitry made up of serially connected resistors that are serially bridged together by way of magnet-controlled switches which are activated as the float is variably positioned in place by the fluid confined in a container whereby the serially connected resistors can form a closed circuitry to indicate the level of the fluid in a container via readings on a display of a gauge. The housing tube is provided with a number of grooves on the outer surface thereof so as to prevent the float from getting stuck on the housing tube due to volume expansion of the float in operation.

### BACKGROUND OF THE INVENTION

The present invention relates to an improved armless fluid level measuring device having a sealed housing tube and an externally exposed float. The float is slidably attached to the outer surface of the housing tube in which an elongated PC board is sealedly confined so as to protect the PC board from being sabotaged or eroded by fluid chemicals. The float provided with a plurality of high density magnet is slidable along the external surface of the housing tube. The PC board has a circuitry made up of serially connected resistors that are selectively bridged together by way of magnet-controlled switches which are activated as the float is variably positioned in place by the fluid confined in a container whereby the serially connected resistors can form a closed circuitry to indicate the level of the fluid in a container via readings on a display of a gauge. The housing tube is provided with a number of grooves on the outer surface thereof so as to prevent the float from getting stuck on the housing tube due to the volume expansion of the float in operation.

Referring to FIG. 1, a conventional armless fluid level measuring device 1 is equipped with an open ended housing tube 25 via which fluid can freely flow in and out so as to permit a float 20 confined in the housing tube 25 to be variably positioned in response to the fluid level in a container, such as a gas tank or reservoir. A PC board 30 housed in the housing tube 25 is provided with a circuit made up of a plurality of serially connected resistors that are bridged by way of a plurality of magnet actuated switches. The float 20 is equipped with magnets that can drive the magnet actuated switch to turn on individually when the magnets come into magnetically effect with one of the magnet actuated switches whereby the fluid level in the container can be actually measured by the slidable float and the serially connected PC board.

Such a prior armless fluid level measuring device 1 is associated with several disadvantages in practical use:

1. The float confined in the housing tube and plunged in fluid is easily got stuck as a result of volume expansion thereof in practical operation.

2. The PC board is easily damaged by fluid containing erosive chemicals, causing the PC board out of function frequently.

### SUMMARY OF THE INVENTION

Therefore, the primary object of the present invention is to provide an improved armless fluid level measuring device having an externally exposed float and a sealed housing tube. It can be commonly applied to all kinds of fluid for measurement of the level thereof in a container in a more precise manner as a result of the float being free of getting stuck inside the housing tube in operation.

Another object of the present invention is to provide an improved armless fluid level measuring device which is equipped with a sealed housing tube that can guard the PC board from being chemically damaged by fluid in which the housing tube is plunged.

One further object of the present invention is to provide an improved armless fluid level measuring device having a housing tube onto which is externally mounted a float slidable up and down along the outer surface thereof. The housing tube is provided with a plurality of grooves on the external surface thereof so as to permit the float to slide freely in response to variation of the fluid level without getting stuck as a result of volume expansion of the float.

### BRIEF DESCRIPTION OF THE DRAWINGS

FIG. 1 is a diagram showing a conventional armless fluid level measuring device with a float slidably disposed in a housing;

FIG. 2 is a diagram showing the PC board housing in a sealed housing tube of the present invention;

FIG. 3 is a perspective diagram of the armless fluid level measuring device of the present invention;

FIG. 4 is a diagram showing the structure of the housing tube of the present invention.

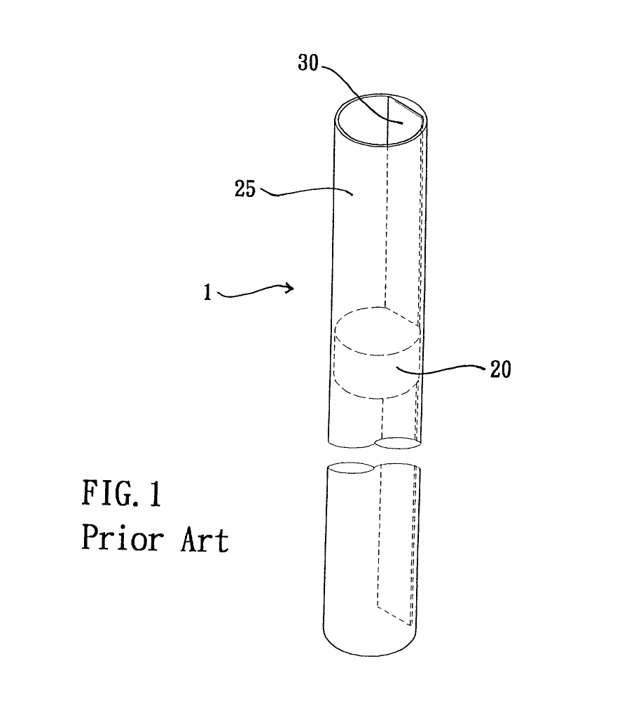

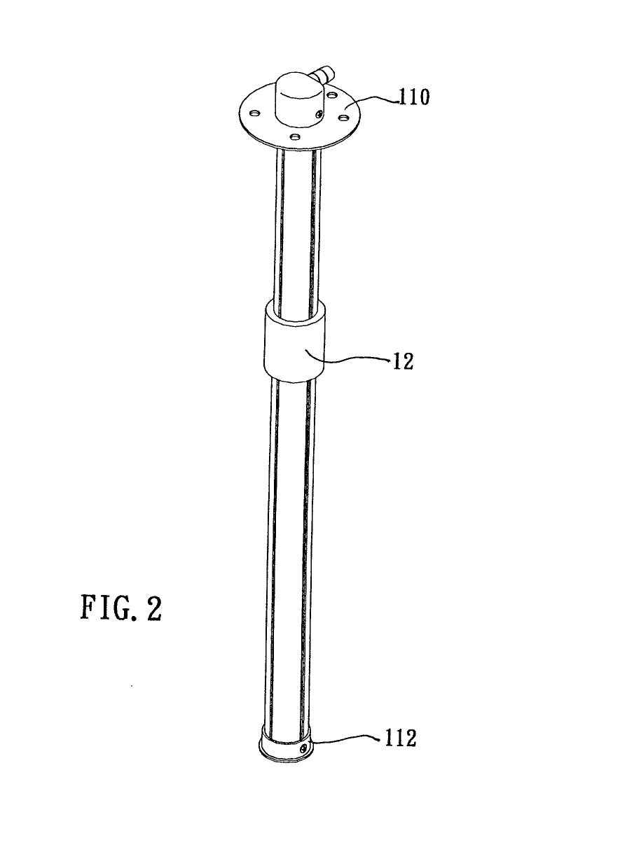

### DETAILED DESCRIPTION OF A PREFERRED EMBODIMENT

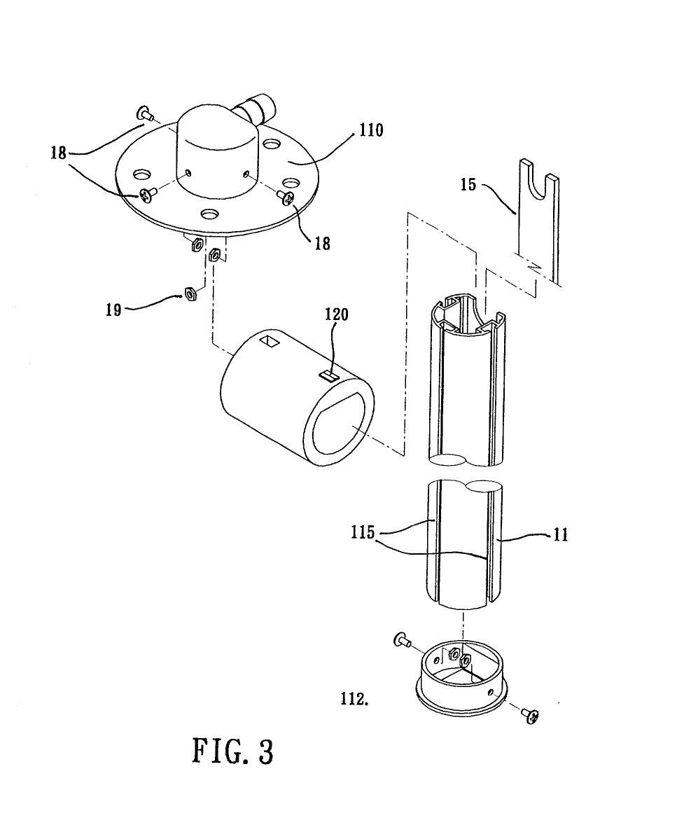

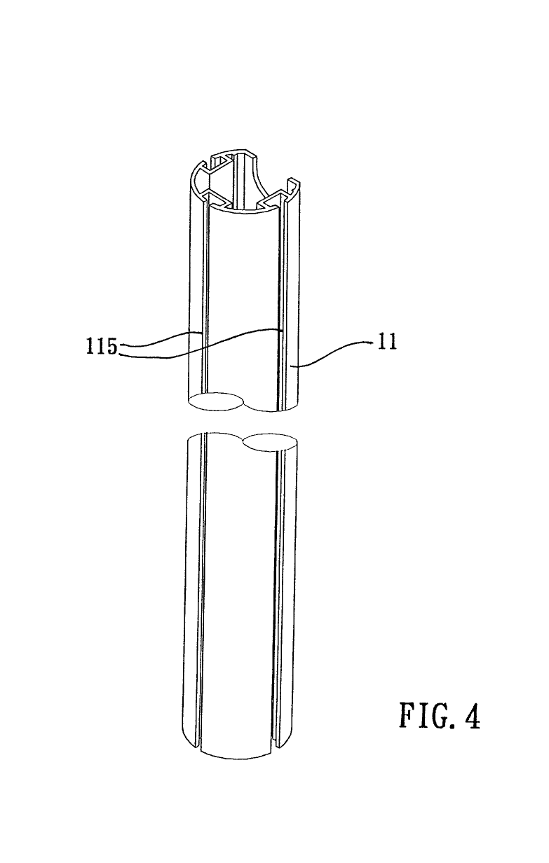

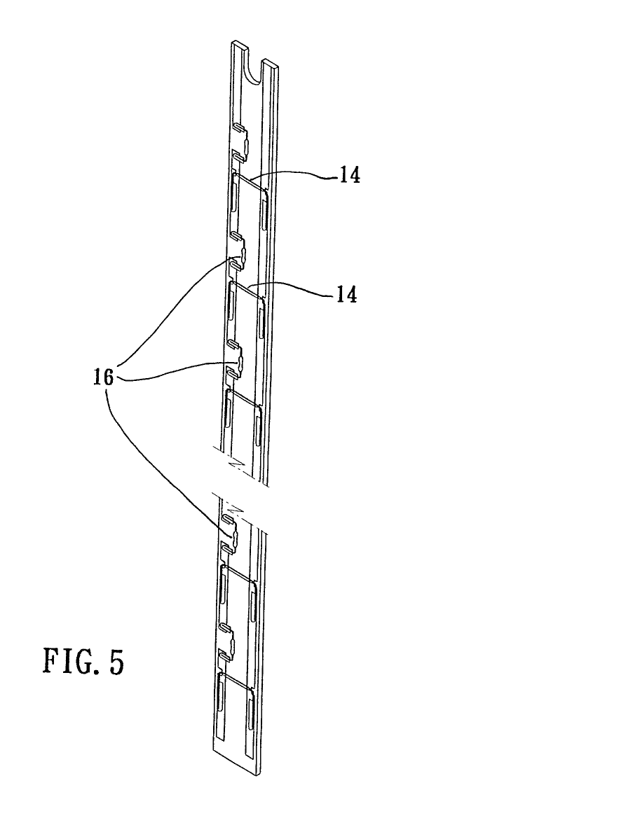

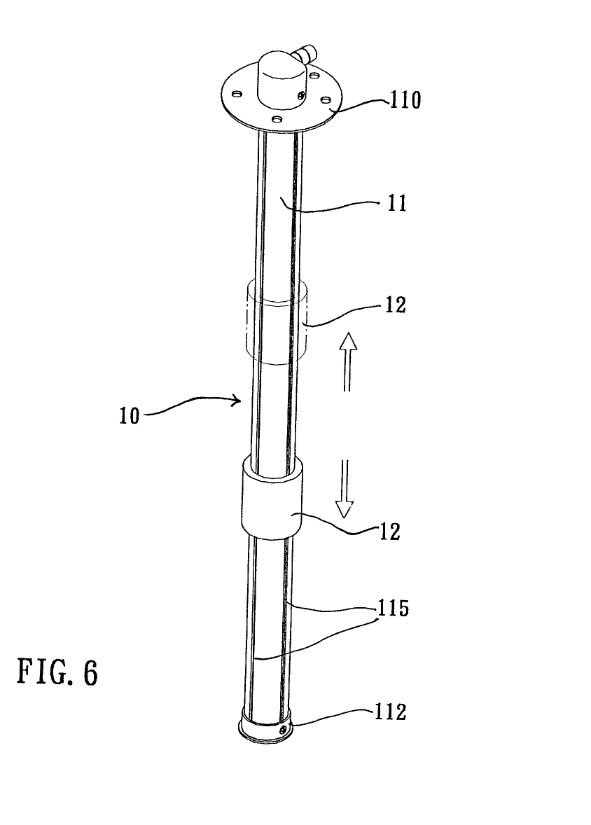

Referring to FIG. 3, an armless fluid level measuring device 10 of the present invention is placed in a container comprises a housing tube 11 having both ends thereof sealedly closed by a top sealing cap 110 and a bottom sealing cap 112 so as to stop fluid confined in a container from entering the housing tube 11.

The PC board 15 received in the housing tube 11 having a circuitry made up of a plurality of serially connected resistors 16 that are electrically coupled by a plurality of magnet-actuated switches 14.

A float 12 externally mounted onto the housing tube 11 having magnets 120 fixed thereon; whereby when the armless fluid level measuring device 10 is plunged in fluid of a container, the float 12 is accordingly positioned by a fluid level in the container so as to make one of the magnet-actuated switches 14 on the PC board 15 turned on, resulting in an indication of the fluid level via digital reading on a gauge.

The armless fluid level measuring device 10 has a housing tube 11 which is provided with a plurality of axially extended grooves 115 on the external surface thereof whereby fluid can be freely expelled when the externally mounted float 12 can smoothly move without getting stuck in operation due to volume expansion.

I claim:

1. An armless fluid level measuring device placed in a container, comprising:
a housing tube having both ends thereof sealedly closed by a top sealing cap and a bottom sealing cap so as to stop fluid confined in a container from entering said housing tube;
a PC board received in said housing tube having a circuitry made up of a plurality of serially connected resistors that are electrically coupled by a plurality of magnet-actuated switches;
a float externally mounted onto said housing tube having magnets fixed thereon;
whereby when said armless fluid level measuring device is plunged in fluid of a container, said float is accordingly positioned by a fluid level in said container so as to make one of said magnet-actuated switches on said PC board turned on, resulting in an indication of the fluid level via digital reading on a gauge.

2. The armless fluid level measuring device as claimed in claim 1 wherein said housing tube is provided with a plurality of axially extended grooves on the external surface thereof whereby fluid can be freely expelled when said externally mounted float can smoothly move without getting stuck in operation due to volume expansion.
